(19) United States
(12) Patent Application Publication
(10) Pub. No.: US 2026/0178649 A1
(43) Pub. Date: Jun. 25, 2026

(54) INFORMATION PROCESSING APPARATUS, INFORMATION PROCESSING SYSTEM, INFORMATION PROCESSING METHOD, AND RECORDING MEDIUM

(71) Applicants: Toshiharu NAKASHIMA, Kanagawa (JP); Hirotatsu ASAI, Tokyo (JP); Takeshi SUZUKI, Kanagawa (JP); Yuuki MOGI, Kanagawa (JP)

(72) Inventors: Toshiharu NAKASHIMA, Kanagawa (JP); Hirotatsu ASAI, Tokyo (JP); Takeshi SUZUKI, Kanagawa (JP); Yuuki MOGI, Kanagawa (JP)

(21) Appl. No.: 19/420,808

(22) Filed: Dec. 16, 2025

(30) Foreign Application Priority Data
Dec. 19, 2024 (JP) 2024-224470

(51) Int. Cl. G06F 16/353; G06F 16/358

(52) U.S. Cl. CPC G06F 16/353; G06F 16/358

(57) ABSTRACT

An information processing apparatus communicably connected with a terminal apparatus includes a memory and circuitry. The memory stores a plurality of reference data records prepared in advance to serve as a reference for a user to respond to an inquiry and a plurality of inquiry history data records each indicating a history of an inquiry received in a past. The circuitry generates distribution information of the plurality of reference data records in which the plurality of reference data records is distributed along a predetermined axis and distribution information of the plurality of inquiry history data records in which the plurality of inquiry history data records is distributed along the predetermined axis, and outputs data including the generated distribution information of the plurality of reference data records and the generated distribution information of the plurality of inquiry history data records to the terminal apparatus for display at the terminal apparatus.

### CROSS-REFERENCE TO RELATED APPLICATIONS

This patent application is based on and claims priority pursuant to 35 U.S.C. § 119(a) to Japanese Patent Application No. 2024-224470, filed on Dec. 19, 2024, in the Japan Patent Office, the entire disclosure of which is hereby incorporated by reference herein.

### BACKGROUND

### Technical Field

Embodiments of the present disclosure relate to an information processing apparatus, an information processing system, an information processing method, and a recording medium.

### Related Art

When an operator responds to an inquiry received from a customer, the operator refers to a reference data record relevant to the inquiry among a plurality of reference data records prepared in advance to serve as a reference for the operator to respond to inquiries from customers.

Providing a comprehensive view of inquiry histories enables the operator to respond to more inquiries.

### SUMMARY

The present disclosure described herein provides an information processing apparatus communicably connected with a terminal apparatus. The information processing apparatus includes a memory and circuitry. The memory stores a plurality of reference data records prepared in advance to serve as a reference for a user to respond to an inquiry and a plurality of inquiry history data records each indicating a history of an inquiry received in a past. The circuitry generates distribution information of the plurality of reference data records in which the plurality of reference data records is distributed along a predetermined axis and distribution information of the plurality of inquiry history data records in which the plurality of inquiry history data records is distributed along the predetermined axis, and outputs data including the generated distribution information of the plurality of reference data records and the generated distribution information of the plurality of inquiry history data records to the terminal apparatus for display at the terminal apparatus.

The present disclosure described herein provides an information processing system including the above-described information processing apparatus and the terminal apparatus including terminal circuitry. The terminal circuitry displays, on a display, the distribution information of the plurality of reference data records and the distribution information of the plurality of inquiry history data records.

The present disclosure described herein provides an information processing method performed by a computer communicably connected with a terminal apparatus. The information processing method includes storing a plurality of reference data records prepared in advance to serve as a reference for a user to respond to an inquiry and a plurality of inquiry history data records each indicating a history of an inquiry received in a past, generating distribution information of the plurality of reference data records in which the plurality of reference data records is distributed along a predetermined axis and distribution information of the plurality of inquiry history data records in which the plurality of inquiry history data records is distributed along the predetermined axis, and outputting data including the generated distribution information of the plurality of reference data records and the generated distribution information of the plurality of inquiry history data records to the terminal apparatus for display at the terminal apparatus.

The present disclosure described herein provides a non-transitory recording medium storing a plurality of instructions which, when executed by one or more processors, causes the one or more processors to perform an information processing method. The information processing method includes storing a plurality of reference data records prepared in advance to serve as a reference for a user to respond to an inquiry and a plurality of inquiry history data records each indicating a history of an inquiry received in a past, generating distribution information of the plurality of reference data records in which the plurality of reference data records is distributed along a predetermined axis and distribution information of the plurality of inquiry history data records in which the plurality of inquiry history data records is distributed along the predetermined axis, and outputting data including the generated distribution information of the plurality of reference data records and the generated distribution information of the plurality of inquiry history data records to the terminal apparatus for display at the terminal apparatus.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an example configuration of an information processing system;

FIG. 2 is a diagram illustrating an example hardware configuration of a computer;

FIG. 3 is a diagram illustrating an example functional configuration of the information processing system;

FIG. 4 is a table illustrating an example inquiry history dataset;

FIG. 5 is a table illustrating an example reference dataset;

FIG. 6 is a table illustrating example analysis result data;

FIG. 7 is a view of an example display of an analysis result;

FIG. 8 is a sequence diagram illustrating an example process performed by the information processing system;

FIG. 9 is a flowchart illustrating an example process of analyzing data records included in each dataset;

FIG. 10 is a view of an example display of a dataset registration screen;

FIG. 11 is a view of an example display of an analysis result screen;

FIG. 12 is a view of example user interaction on the analysis result screen;

FIG. 13 is a view of another example user interaction on the analysis result screen;

FIG. 14 is a diagram illustrating an example functional configuration of an information processing system;

FIG. 15 is a sequence diagram illustrating an example process performed by the information processing system;

FIG. 16 is a flowchart illustrating an example process of determining a classification category to be presented to a user;

FIG. 17 is a view of an example display of the analysis result screen; and

FIG. 18 is a view of another example display of the analysis result screen.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

### First Embodiment

### Configuration of Information Processing System

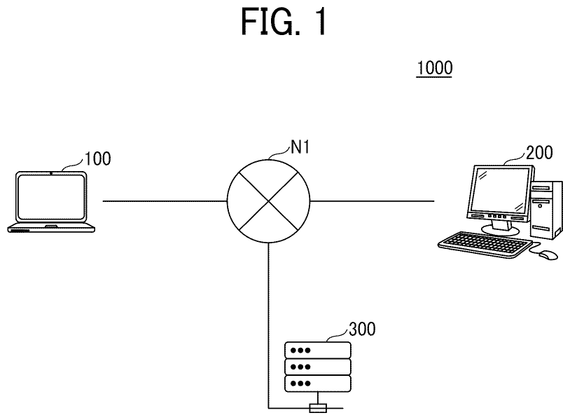

FIG. 1 is a diagram illustrating an example configuration of an information processing system 1000. The information processing system 1000 illustrated in FIG. 1 includes a terminal apparatus 100, an information processing apparatus 200, and a data server 300. The terminal apparatus 100, the information processing apparatus 200, and the data server 300 communicate with each other via a network N1. The network N1 is, for example, the Internet or a local area network (LAN).

The terminal apparatus 100 is a terminal apparatus having a display function. The terminal apparatus 100 may be, for example, a mobile terminal or a personal computer (PC). Examples of the mobile terminal include a smartphone, a mobile phone, a tablet terminal, a game console, a personal digital assistant (PDA), a digital camera, and a wearable terminal.

The terminal apparatus 100 displays a screen and receives an operation from a user. In response to the operation from the user, the terminal apparatus 100 transmits, for example, a request such as a dataset registration request or a screen output request to the information processing apparatus 200.

The information processing apparatus 200 is a server apparatus that performs processing in response to a request from the terminal apparatus 100. The information processing apparatus 200 may be, for example, a cloud server or an on-premises server.

In response to a request from the terminal apparatus 100, the information processing apparatus 200 analyzes data records included in a dataset or performs display control such as the transmission of display screen data to the terminal apparatus 100. The analysis of data records included in a dataset refers to the classification of the data records included in the dataset or the distribution of the data records included in the dataset. The classification of the data records refers to classifying each of the data records into a corresponding one of two or more groups (classification categories). The distribution of the data records refers to determining the position of each data record based on the contents of the data record. The position of each data record reflects the contents or the feature of the data record. Therefore, visualizing the plurality of data records in their respective positions allows the user to recognize similarities among the plurality of data records and the types of data records included in the dataset.

The data server 300 is a server that stores datasets. The data server 300 may be, for example, a cloud server or an on-premises server.

In response to a request from the terminal apparatus 100 or the information processing apparatus 200, the data server 300 stores or reads a dataset. In a case where the terminal apparatus 100 or the information processing apparatus 200 stores a dataset, the information processing system 1000 may not include the data server 300.

In FIG. 1, the terminal apparatus 100, the information processing apparatus 200, and the data server 300 are connected to the same network N1. In another embodiment, the terminal apparatus 100, the information processing apparatus 200, and the data server 300 may be connected to different networks.

The information processing apparatus 200 or the data server 300 may be any apparatus having a communication function, such as an output apparatus, a head-up display (HUD), an industrial machine, an imaging apparatus, a sound collection apparatus, a medical apparatus, a network-connected home appliance, a connected car (vehicle), a laptop, a mobile phone, a smartphone, a tablet terminal, a game console, a PDA, a digital camera, a wearable PC, or a desktop PC. The output apparatus may be, for example, a projector (PJ), an interactive white board (IWB), which is an electronic whiteboard having a blackboard function and supporting a bi-directional communication function, or digital signage.

### Hardware Configuration of Information Processing System

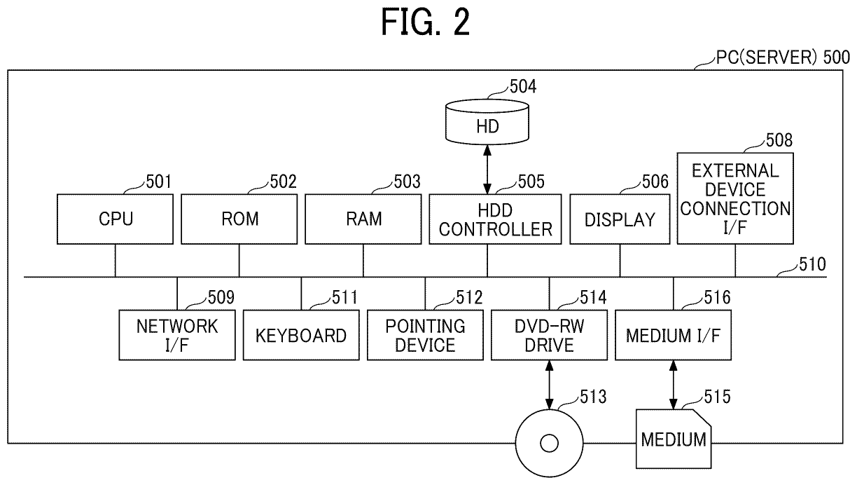

The terminal apparatus 100, the information processing apparatus 200, and the data server 300 illustrated in FIG. 1 may include a computer 500 having a hardware configuration illustrated in FIG. 2, for example.

FIG. 2 is a diagram illustrating an example hardware configuration of the computer 500. As illustrated in FIG. 2, the computer 500 includes, for example, a central processing unit (CPU) 501, a read-only memory (ROM) 502, a random-access memory (RAM) 503, a hard disk (HD) 504, a hard disk drive (HDD) controller 505, a display 506, an external device connection interface (I/F) 508, a network I/F 509, a bus line 510, a keyboard 511, a pointing device 512, a digital versatile disk-rewritable (DVD-RW) drive 514, and a medium I/F 516.

The CPU 501 controls the operation of the computer 500. The ROM 502 stores, for example, programs such as an initial program loader (IPL) for executing the CPU 501. The RAM 503 is, for example, used as a work area for the CPU 501. The HD 504 stores, for example, various data including programs. The HDD controller 505 controls, for example, the reading and writing of various data from and to the HD 504 under the control of the CPU 501.

The display 506 displays, for example, various types of information such as a cursor, menus, windows, texts, and images. The external device connection I/F 508 is an interface for connecting various external devices to the computer 500. Examples of the external devices include a universal serial bus (USB) memory and a printer. The network I/F 509 is an interface for performing data communication via, for example, the network N1. The bus line 510 includes, for example, an address bus and a data bus for electrically connecting the above-described components such as the CPU 501 illustrated in FIG. 2 to each other.

The keyboard 511 is an example of an input device including a plurality of keys for inputting, for example, characters, numerical values, and various instructions. The pointing device 512 is an example of an input device that allows a user to select or execute various instructions, select a target to be processed, and move a cursor being displayed. The DVD-RW drive 514 controls the reading and writing of various data from and to a DVD-RW 513, which is an example of a removable recording medium. The DVD-RW 513 may be an optical storage medium such as a digital versatile disc-recordable (DVD-R). The medium I/F 516 controls the reading and writing (storing) of data from and to a recording medium 515 such as a flash memory.

### Functional Configuration of Information Processing System According to First Embodiment

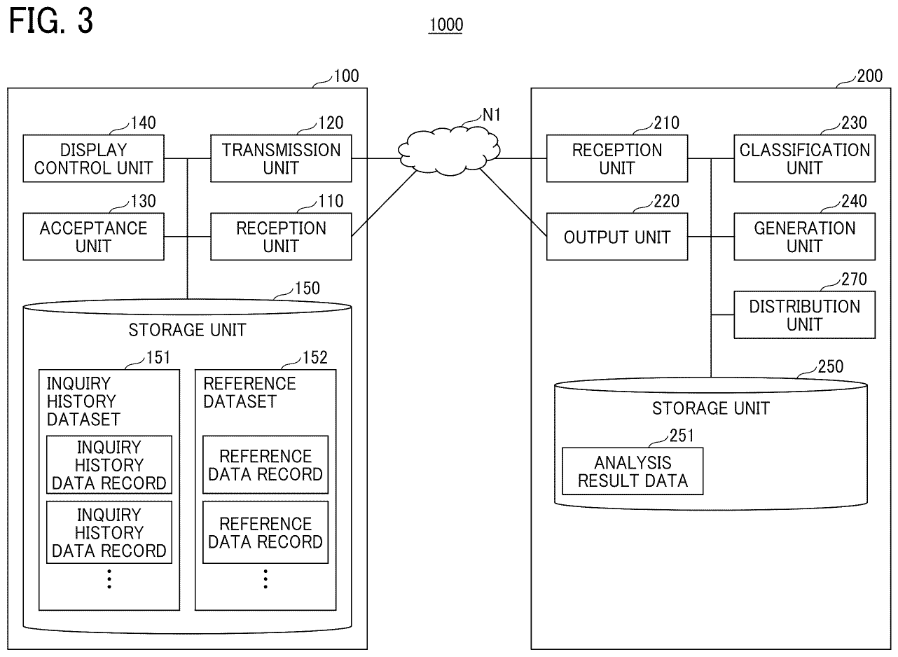

FIG. 3 is a diagram illustrating an example functional configuration of the information processing system 1000.

### Terminal Apparatus

The terminal apparatus 100 includes a reception unit 110, a transmission unit 120, an acceptance unit 130, a display control unit 140, and a storage unit 150. The reception unit 110, the transmission unit 120, the acceptance unit 130, the display control unit 140, and the storage unit 150 are, for example, implemented by a process performed by the CPU 501 according to a program loaded from the HD 504 into the RAM 503 illustrated in FIG. 2.

The reception unit 110 receives data from the information processing apparatus 200 or the data server 300. The reception unit 110 receives screen data or an analysis result from the information processing apparatus 200. The reception unit 110 receives a dataset from the data server 300.

The transmission unit 120 transmits data to the information processing apparatus 200 or the data server 300. The transmission unit 120 transmits, for example, a dataset, a request to analyze data records included in the dataset, and setting information to be described later to the information processing apparatus 200. The transmission unit 120 transmits, for example, a dataset, a dataset storage request, and a dataset reading request to the data server 300.

The acceptance unit 130 receives an operation from the user. Examples of the operation from the user include the setting of the setting information to be described later, the selection of a dataset, the pressing of a button, and a zoom in/out operation. The operation from the user may be performed using any means such as a mouse, a keyboard, or a voice.

The display control unit 140 displays a screen corresponding to the screen data received from the information processing apparatus 200 or a screen corresponding to the screen data generated by the terminal apparatus 100. The display control unit 140 may employ any display method. For example, the display control unit 140 may display the screen on a display or project the screen on a projection surface.

The storage unit 150 stores an inquiry history dataset 151 and a reference dataset 152 to be described later.

### Dataset

A dataset refers to a collection of data records. Hereinafter, in a case where there is no particular distinction between the inquiry history dataset 151 and the reference dataset 152, the inquiry history dataset 151 and the reference dataset 152 may be simply referred to as “dataset.”

The inquiry history dataset 151 is described. The inquiry history dataset 151 is a collection of inquiry history data records. That is, each data record included in the inquiry history dataset 151 is a data record indicating a history of an inquiry received in the past (hereinafter referred to as an “inquiry history data record”). Each inquiry history data record indicates a history of an inquiry received in the past.

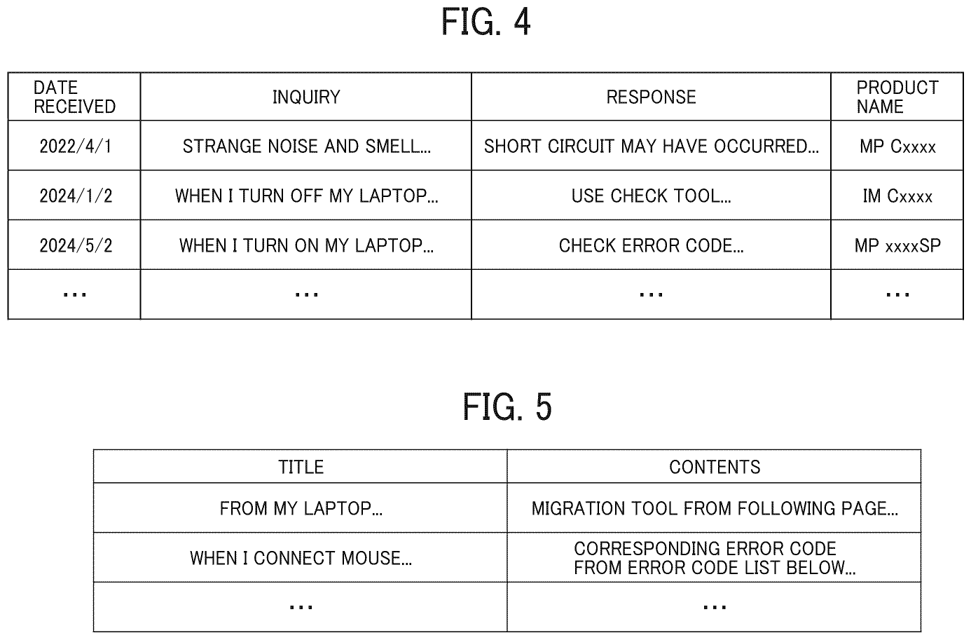

FIG. 4 is a table illustrating an example of the inquiry history dataset 151. Hereinafter, a dataset of data records each indicating a history of an inquiry received from a customer may be referred to as the inquiry history dataset 151. Specifically, FIG. 4 illustrates an example configuration of the inquiry history dataset 151, which is an example of a dataset of data records each indicating a history of an inquiry received from a customer.

Each data record indicating a history of an inquiry received from a customer includes items “date received,” “inquiry,” “response,” and “product name.”

The item “date received” indicates the date and time when an inquiry was received from a customer. The item “inquiry” indicates the contents of the inquiry from the customer. The item “response” indicates a response from a user (hereinafter referred to as an operator) to the inquiry received from the customer. The “product name” indicates which product the customer inquired about. The item “product name” may be product identification information or product number.

In FIG. 4, the inquiry history dataset 151 includes a data record indicating a history of an inquiry received from a customer on Apr. 1, 2022. This data record indicates that the customer inquired about a product “MP Cxxxx,” stating “strange noise and smell . . . ,” and the operator responded to the inquiry, stating that “short circuit may have occurred . . . . ”

In the example illustrated in FIG. 4, data records each indicating a history of a past customer inquiry included in the inquiry history dataset 151 are in the text form. The data records included in the inquiry history dataset 151 are not limited to the text form. As long as the data records included in the inquiry history dataset 151 are in a form suitable for vectorization, the data records may be any form of information, such as images.

In the example illustrated in FIG. 4, the inquiry history dataset 151 includes the data records including the items “date received,” “inquiry,” “response,” and “product name.” However, the items of the data records included in the inquiry history dataset 151 are not limited thereto. The data records included in the inquiry history dataset 151 may include additional items or part of the items may be omitted therefrom.

The reference dataset 152 is described. The reference dataset 152 is a collection of reference data records. That is, data records included in the reference dataset 152 are reference data records. The reference data records are data records prepared in advance to serve as a reference for the operator to respond to an inquiry.

As an example, the reference data records included in the reference dataset 152 include at least one of a product manual and a history of a response to an inquiry received in the past such as frequently asked questions and answers. FIG. 5 illustrates an example of the reference dataset 152.

Each reference data record includes items “title” and “contents.”

The item “title” indicates the title of a product manual or the contents of an inquiry received in the past. The item “contents” indicates the contents of the product manual or a response to the inquiry.

In FIG. 5, one of the data records included in the reference dataset 152 includes an inquiry received in the past, stating “from my laptop . . . ,” and a response to the inquiry, stating “a migration tool from the following page . . . . ”

In the example illustrated in FIG. 5, the data records included in the reference dataset 152 are in the text form. The data records included in the reference dataset 152 are not limited to the text form. As long as the data records included in the reference dataset 152 are suitable for vectorization, the data records may be any form of information, such as images.

In the example illustrated in FIG. 5, the reference dataset 152 includes the data records including the items “title” and “contents.” However, the items of the data records included in the reference dataset 152 are not limited thereto. The data records included in the reference dataset 152 may include additional items or part of the items may be omitted therefrom.

### Information Processing Apparatus

The information processing apparatus 200 includes a reception unit 210, an output unit 220, a classification unit 230, a generation unit 240, a storage unit 250, and a distribution unit 270. The reception unit 210, the output unit 220, the classification unit 230, the generation unit 240, the storage unit 250, and the distribution unit 270 are, for example, implemented by a process performed by the CPU 501 according to a program loaded from the HD 504 into the RAM 503 illustrated in FIG. 2.

The reception unit 210 receives data from the terminal apparatus 100 or the data server 300. The reception unit 210 receives, for example, a dataset, a request to analyze data records included in the dataset, and setting information to be described later from the terminal apparatus 100. The reception unit 210 receives a dataset from the data server 300.

The output unit 220 outputs, for example, screen data and an analysis result. The output unit 220 outputs data to the terminal apparatus 100 or the data server 300. The output unit 220 outputs the screen data and the analysis result to the terminal apparatus 100. The output unit 220 outputs the analysis result, an analysis result storage request, and a dataset request to the data server 300. Outputting includes transmitting data to a terminal apparatus or an apparatus connected by wire and transmitting data to the terminal apparatus 100 via the network N1. The output unit 220 may also output data to be displayed on a display.

The classification unit 230 classifies data records included in a dataset. Specifically, the classification unit 230 classifies each of the data records (inquiry history data records) included in the inquiry history dataset 151 and each of the data records (reference data records) included in the reference dataset 152 into a corresponding one of the classification categories. A classification process is described in detail later.

The generation unit 240 generates various data. The generation unit 240 generates data for displaying a screen on the terminal apparatus 100. The data for displaying a screen may be screen data itself or data to be used for generating the screen data. Examples of the data to be used for generating the screen data include, for example, distribution data of reference data records and distribution data of inquiry history data records. The distribution data is an example of distribution information.

The generation unit 240 generates distribution data of reference data records and distribution data of inquiry history data records based on analysis result data to be described later. Hereinafter, the distribution data of the reference data records and the distribution data of the inquiry history data records may be collectively referred to as “distribution data.” The distribution data of the reference data records is an example of distribution information of the reference data records. The distribution data of the inquiry history data records is an example of distribution information of the inquiry history data records.

The distribution data of the reference data records refers to data in which the data records included in the reference dataset 152 are distributed along a predetermined axis. The distribution data of the inquiry history data records refers to data in which the data records included in the inquiry history dataset 151 are distributed along the predetermined axis.

The predetermined axis refers to a coordinate axis of a vector obtained by vectorizing data records included in a dataset and performing a predetermined vectorization process thereon. The axis of the distribution data of the reference data records and the axis of the distribution data of the inquiry history data records are the same.

The distribution data may include position information of each data record included in the dataset and information regarding a figure to be displayed.

The storage unit 250 stores analysis result data 251 to be described later. The storage unit 250 also stores each dataset received by the reception unit 210.

The distribution unit 270 distributes data records included in each dataset. Specifically, the distribution unit 270 distributes data records (inquiry history data records) included in the inquiry history dataset 151 and data records (reference data records) included in the reference dataset 152 and obtains position information of each data record to be described later. A distribution process is described in detail later.

### Analysis Result Data

The analysis result data 251 includes a result of the classification of the data records included in the inquiry history dataset 151 and a result of the classification of the data records included in the reference dataset 152, which have been obtained by the classification unit 230. The analysis result data 251 includes a result of the distribution of the data records included in the inquiry history dataset 151 (the distribution data of the inquiry history data records) and a result of the distribution of the data records included in the reference dataset 152 (the distribution data of the reference data records), which have been obtained by the distribution unit 270. In other words, the analysis result data 251 includes the result of the analysis of the data records included in the inquiry history dataset 151 and the result of the analysis of the data records included in the reference dataset 152.

The analysis result data 251 includes, as items, the contents of the data records included in each dataset, dataset identification information, classification category information, and position information.

The contents of the data records included in each dataset include part or all of the items included in the inquiry history dataset 151 or the reference dataset 152.

The dataset identification information refers to information for identifying the dataset. Any information that identifies the dataset may be used as the dataset identification information. The dataset identification information may be, for example, the name of the dataset or the number indicating the dataset.

The classification category information refers to information that identifies a classification category into which the classification unit 230 has classified data records. Any information that identifies the classification category may be used as the classification category information. The classification category information may be, for example, the classification number, the name of the classification category, or a term representing the classification category.

The position information refers to information that specifies the position which has been determined by the distribution unit 270 and at which a corresponding data record is displayed when the analysis result data is displayed. As long as each data record is displayed in two dimensions, the position information may be represented by an X-coordinate and a Y-coordinate. Further, as long as the position information specifies the position at which the corresponding data record is displayed, the position information is not necessarily represented by coordinates. The position information indicates the data distribution. The position information indicates the position of each data record in the distribution.

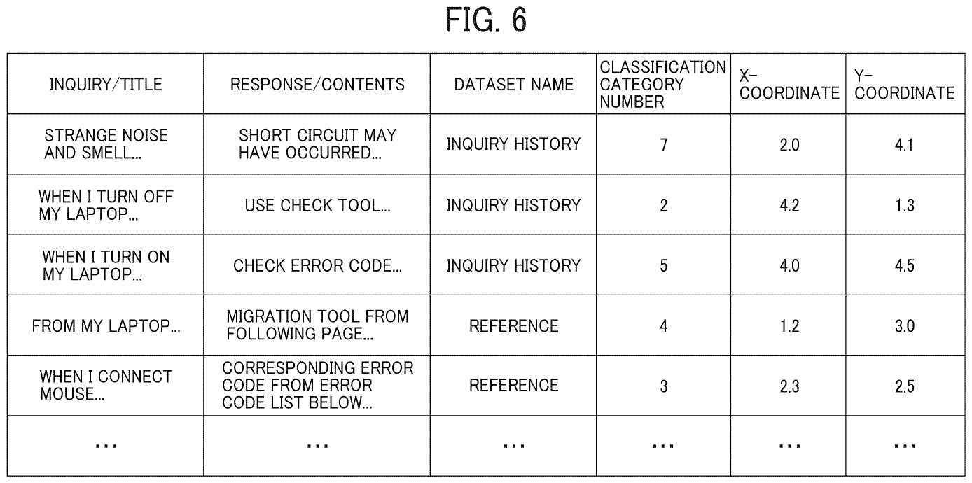

FIG. 6 illustrates an example configuration of the analysis result data 251.

The analysis result data 251 includes items “inquiry/title,” “response/contents,” “dataset name,” “classification category number,” “X-coordinate,” and “Y-coordinate.”

The items “inquiry/title” and “response/contents” are examples of the contents of data records included in each dataset. The item “dataset name” is an example of the dataset identification information. The item “classification category number” is an example of the classification category information. The items “X-coordinate” and “Y-coordinate” are examples of the position information.

In FIG. 6, one of the data records in the inquiry history dataset 151 includes an inquiry “strange noise and smell . . . ” and is classified into the classification category with the classification category number 7. This data record is to be displayed at the X-coordinate=2.0 and the Y-coordinate=4.1.

In FIG. 6, one of the reference data records in the reference dataset 152 includes the title “from my laptop . . . ” and the contents “a migration tool from the following page . . . ” and is classified into the classification category with the classification category number 4. This data record is to be displayed at the X-coordinate=1.2 and the Y-coordinate=3.0.

In FIG. 6, the analysis result data 251 includes both the result of the analysis of the data records included in the inquiry history dataset 151 and the result of the analysis of the data records included in the reference dataset 152. In another embodiment, data including the result of the analysis of the data records included in the inquiry history dataset 151 and data including the result of the analysis of the data records included in the reference dataset 152 may be separate data.

### Example Display of Analysis Result Data

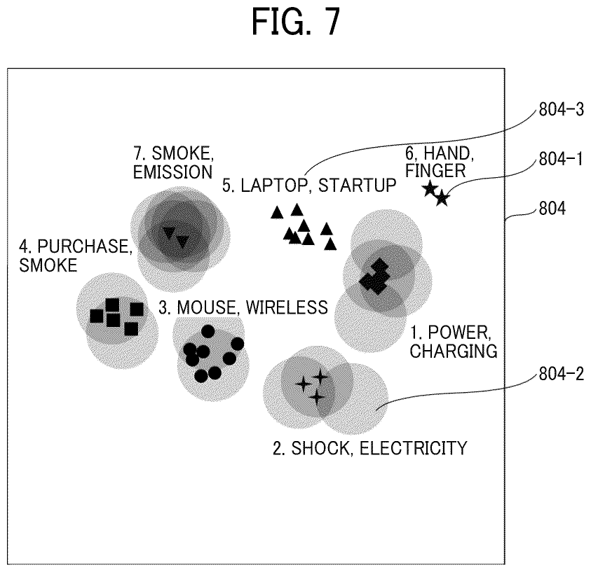

Example display of the analysis result data is described with reference to FIG. 7. FIG. 7 is a view of the example display of the analysis result. By referring to the analysis result being displayed, a user who manages the reference dataset 152 (hereinafter referred to as “administrator”) recognizes the distribution of the data records included in the inquiry history dataset 151 and the distribution of the data records included in the reference dataset 152.

The analysis result data is displayed in an analysis result display field 804. The analysis result display field 804 includes FIGS. 804-1 and 804-2, and pieces of classification category information 804-3. Each FIG. 804-1 represents a corresponding one of the data records (inquiry history data records) included in the inquiry history dataset 151. Each FIG. 804-2 represents a corresponding one of the data records (reference data records) included in the reference dataset 152. Each classification category information 804-3 indicates a corresponding one of the classification categories.

The FIGS. 804-1 each representing the corresponding one of the data records included in the inquiry history dataset 151 represent the distribution of the data records included in the inquiry history dataset 151. Each FIG. 804-1 is displayed at a position based on the position information included in the analysis result data. Each FIG. 804-1 is an example of a first figure.

The FIGS. 804-1 each representing the corresponding one of the data records included in the inquiry history dataset 151 have different shapes depending on the classification categories into which the data records are classified. The different shapes mean that the figures are different in appearance, such as color, form, size, or transparency.

In FIG. 7, the FIGS. 804-1 each representing the corresponding one of the data records included in the inquiry history dataset 151 have different shapes depending on the classification categories into which the data records are classified. For example, data records classified into the classification category with the classification category number 6, whose representative term is “hand, finger,” are represented by star-shaped figures. Similarly, data records classified into the classification category with the classification category number 5, whose representative term is “laptop, startup,” are represented by triangular figures.

The FIGS. 804-2 each representing the corresponding one of the data records included in the reference dataset 152 represent the distribution of the data records included in the reference dataset 152. Each FIG. 804-2 is displayed at a position based on the position information included in the analysis result data. Each FIG. 804-2 is an example of a second figure.

The FIGS. 804-2 have a different shape from the FIGS. 804-1.

In FIG. 7, the FIGS. 804-2 are displayed as transparent circles (with a transparency of one or higher). The FIGS. 804-2 may have the same size. Alternatively, the FIGS. 804-2 may have different sizes according to the sizes of the respective data records.

Displaying the FIGS. 804-2 as large circles allows the administrator to easily recognize what contents the reference data records include. Additionally, differentiating the sizes of the FIGS. 804-1 and the sizes of the FIGS. 804-2 allows the administrator to easily recognize whether the displayed figures represent the data records included in the inquiry history dataset 151 or the data records included in the reference dataset 152.

The analysis result display field 804 displays the distribution of the data records included in the inquiry history dataset 151 and the distribution of the data records included in the reference dataset 152 together. Displaying the distributions together means displaying both of the distributions on a single screen. The analysis result display field 804 may display the distributions in an overlapping manner or side by side.

In FIG. 7, the distribution of the data records (inquiry history data records) included in the inquiry history dataset 151 and the distribution of the data records (reference data records) included in the reference dataset 152 are displayed in a superimposed or overlapping manner.

Each classification category information 804-3 indicates the classification category into which the data records displayed in the vicinity of the classification category information 804-3 are classified.

In this way, displaying the distribution of the data records included in the inquiry history dataset 151 and the distribution of the data records included in the reference dataset 152 together allows the administrator to recognize the differences therebetween.

For example, in FIG. 7, no large circles are displayed at the positions where the triangular figures are displayed. In this case, the administrator recognizes the difference between the distributions such that there is a plurality of data records classified into the classification category with the classification category number 5 among the data records included in the inquiry history dataset 151 but there are no data records classified into the classification category with the classification category number 5 among the data records included in the reference dataset 152.

For example, in FIG. 7, a few inverted triangular figures are displayed, around which large circles are displayed in a concentrated manner. In this case, the administrator recognizes the difference between the distributions such that the number of data records classified into the classification category with the classification category number 7 among the data records included in the inquiry history dataset 151 is small while the number of data records classified into the classification category with the classification category number 7 among the data records included in the reference dataset 152 is large.

By recognizing the difference between the distribution of the data records included in the inquiry history dataset 151 and the distribution of the data records included in the reference dataset 152, the administrator who manages the reference dataset 152 figures out what data records are desirable to add to or remove from the reference dataset 152.

### Processing Procedure According to First Embodiment

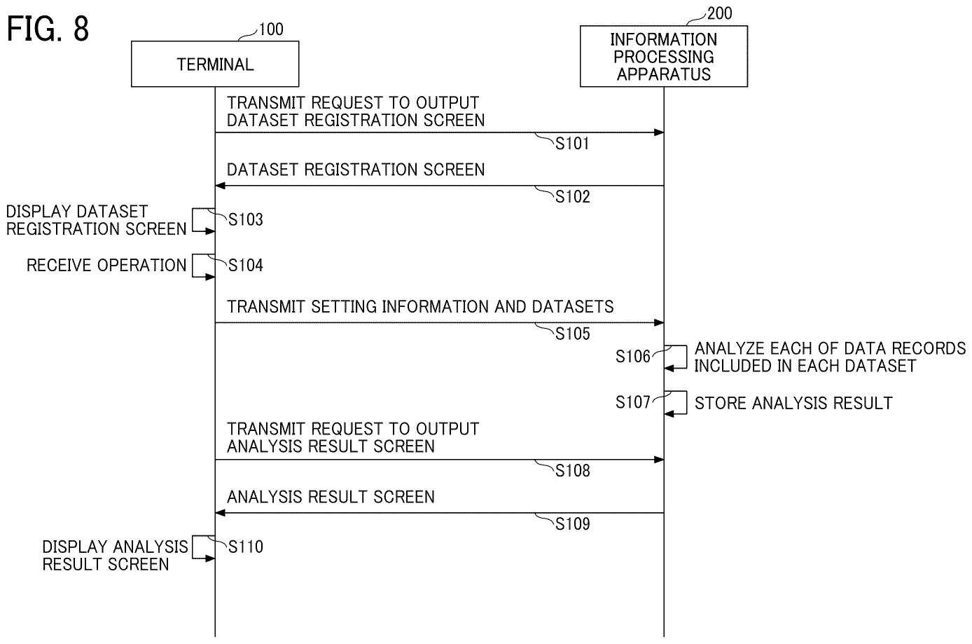

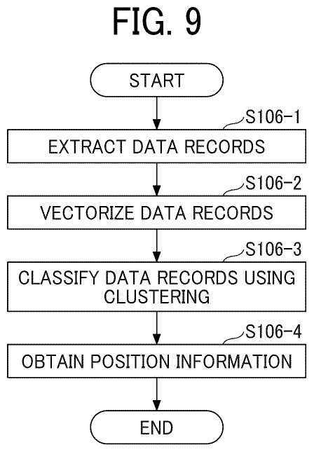

A process performed by the information processing system 1000 is described with reference to FIGS. 8 and 9.

FIG. 8 is a sequence diagram illustrating an example process performed by the information processing system 1000.

In step S101, the transmission unit 120 of the terminal apparatus 100 transmits a request to display a dataset registration screen to the information processing apparatus 200. The reception unit 210 of the information processing apparatus 200 receives the request.

In step S102, in response to the request to display the dataset registration screen received from the terminal apparatus 100 in step S101, the generation unit 240 of the information processing apparatus 200 generates screen data for the dataset registration screen. The output unit 220 of the information processing apparatus 200 outputs the screen data for the dataset registration screen to the terminal apparatus 100. The reception unit 110 of the terminal apparatus 100 receives the screen data for the dataset registration screen from the information processing apparatus 200.

The dataset registration screen includes a setting information setting field and a dataset setting field.

The setting information includes information regarding settings to be applied when data records included in each dataset are analyzed. For example, the setting information includes model setting information, language setting information, and extraction setting information.

The model setting information includes information regarding a model to be used to vectorize the data records.

The language setting information includes information that specifies the language of each dataset. The language setting information is set according to the language of the data records included in each dataset set in the dataset setting field. For example, in a case where the dataset includes data records written in Japanese, the language setting information is set to Japanese.

The extraction setting information includes information that specifies a condition for extracting part of the data records from the inquiry history dataset 151. For example, the extraction setting information may be period information. For example, in a case where the administrator wants to analyze data records of inquiries received during a desired period among the data records included in the inquiry history dataset 151, the administrator sets information that specifies the desired period as the extraction setting information. Similarly, in a case where the administrator wants to analyze data records of inquiries about a desired product among the data records included in the inquiry history dataset 151, the administrator sets information that specifies the product as the extraction setting information.

The dataset setting field is a field in which the administrator sets a plurality of datasets.

In step S103, the display control unit 140 of the terminal apparatus 100 displays the dataset registration screen based on the screen data for the dataset registration screen received in step S102.

In step S104, the acceptance unit 130 of the terminal apparatus 100 receives an operation from the administrator. For example, the administrator performs operations for inputting the setting information and setting datasets on the dataset registration screen. In this case, the acceptance unit 130 of the terminal apparatus 100 receives the operations for inputting the setting information and setting the datasets.

In this example, it is assumed that the administrator has selected the inquiry history dataset 151 and the reference dataset 152 stored in the storage unit 150 of the terminal apparatus 100 as the datasets.

In step S105, the transmission unit 120 of the terminal apparatus 100 transmits the setting information input in step S104 and the inquiry history dataset 151 and the reference dataset 152 selected in step S104 to the information processing apparatus 200. The transmission of the setting information and the datasets may also serve as the transmission of a request to analyze data records included in the datasets. The reception unit 210 of the information processing apparatus 200 receives the setting information, the inquiry history dataset 151, and the reference dataset 152 transmitted from the terminal apparatus 100. The storage unit 250 stores the inquiry history dataset 151 and the reference dataset 152 received by the reception unit 210.

In step S106, the information processing apparatus 200 analyzes each of the data records included in each dataset received in step S105. A process of analyzing the data records included in each dataset is described in detail later.

In step S107, the storage unit 250 of the information processing apparatus 200 stores the analysis result data 251, which is the result of the analysis of the data records included in each dataset and obtained in step S106. The analysis result data 251 includes the result of the analysis of the data records included in the inquiry history dataset 151 and the result of the analysis of the data records included in the reference dataset 152. The analysis result data 251 includes, as items, the contents of the data records included in each dataset, dataset identification information, classification category information, and position information.

In step S108, the transmission unit 120 of the terminal apparatus 100 transmits a request to output an analysis result to the information processing apparatus 200. The reception unit 210 of the information processing apparatus 200 receives the request to output the analysis result from the terminal apparatus 100.

In step S109, in response to the request received in step S108, the generation unit 240 of the information processing apparatus 200 generates distribution data of the data records (inquiry history data records) included in the inquiry history dataset 151 and distribution data of the data records (reference data records) included in the reference dataset 152 based on the analysis result obtained in step S106. In other words, the generation unit 240 generates data for displaying screen data for an analysis result screen.

The output unit 220 of the information processing apparatus 200 outputs the data for displaying the analysis result screen to the terminal apparatus 100. The data for displaying the analysis result screen includes the distribution data of the data records (inquiry history data records) included in the inquiry history dataset 151 and the distribution data of the data records (reference data records) included in the reference dataset 152, which have been generated by the generation unit 240. Specifically, the output unit 220 outputs the data including the distribution data of the data records (inquiry history data records) included in the inquiry history dataset 151 and the distribution data of the data records (reference data records) included in the reference dataset 152, which have been generated by the generation unit 240. The reception unit 110 of the terminal apparatus 100 receives the data for displaying the analysis result screen from the information processing apparatus 200.

In step S110, the display control unit 140 of the terminal apparatus 100 displays the analysis result screen based on the data received in step S109.

In the present embodiment, the terminal apparatus 100 that has transmitted the setting information and the datasets transmits the request to output the analysis result screen and displays the analysis result screen. In another embodiment, a terminal apparatus other than the terminal apparatus 100 that has transmitted the setting information and the datasets may transmit the request to output the analysis result screen, and display the analysis result screen.

In the present embodiment, the terminal apparatus 100 transmits the datasets to the information processing apparatus 200. In another embodiment, the terminal apparatus 100 may transmit each of the data records individually, rather than transmitting the data records as a batch such as a dataset. Further, the terminal apparatus 100 may transmit information indicating the location where the datasets or data records are stored to the information processing apparatus 200, and the information processing apparatus 200 may obtain the datasets or the data records from, for example, the data server 300 based on the information indicating the location where the datasets or the data records are stored.

The process of analyzing the data records included in each dataset (step S106) is described in detail with reference to FIG. 9. FIG. 9 is a flowchart illustrating an example process of analyzing the data records included in each dataset.

In step S106-1, the classification unit 230 extracts part of the data records included in the inquiry history dataset 151 based on the extraction setting information included in the setting information received in step S105.

In a case where the extraction setting information indicates “period: current fiscal year,” the classification unit 230 extracts data records whose “date received” falls within the current fiscal year among the data records included in the inquiry history dataset 151.

In a case where the extraction setting information is not set, the classification unit 230 extracts all the data records included in the inquiry history dataset 151. The subsequent steps are performed on the data records extracted from the inquiry history dataset 151 and the data records included in the reference dataset 152.

In step S106-2, the classification unit 230 vectorizes the data records using the model set in the model setting information included in the setting information received in step S105. The classification unit 230 may vectorize the data records using an embedding model. Alternatively, the classification unit 230 may vectorize the data records using a model trained using specific data records or a model customized for a specific industry.

The classification unit 230 vectorizes the data records to determine the positions of the data records reflecting the features of the data records based on the contents of the data records. With the data records displayed at the respective positions, the administrator recognizes the contents or features of the data records. Further, with the plurality of data records displayed, the administrator recognizes a relationship, such as similarity, among the plurality of data records.

In step S106-3, the classification unit 230 classifies the data records vectorized in step S106-2. The classification unit 230 may classify the data records using a clustering method such as k-means, gaussian mixture model (GMM), ordering points to identify the clustering structure (OPTICS), density-based spatial clustering of applications with noise (DBSCAN), or hierarchical density-based spatial clustering of applications with noise (HDBSCAN). The classification unit 230 determines classification categories when performing clustering, and classifies the data records included in each dataset into the determined classification categories.

The classification is not limited to clustering. The classification unit 230 may classify the data records into pre-determined classification categories based on a rule.

In step S106-4, the distribution unit 270 obtains position information of each data record. Specifically, the distribution unit 270 performs dimensionality reduction on the data records vectorized in step S106-2. The distribution unit 270 may perform the dimensionality reduction using, for example, principal component analysis (PCA), t-distributed stochastic neighbor embedding (t-SNE), or uniform manifold approximation and projection (UMAP). The dimensionality after the dimensionality reduction may be two-dimensional (2D) or three-dimensional (3D). The coordinates of the vector obtained as a result of the dimensionality reduction serve as the position information.

In step S106-2, the coordinate axis of the vector obtained as a result of the dimensionality reduction is a distribution axis. Since the data records included in the inquiry history dataset 151 and the data records included in the reference dataset 152 are subjected to the same vectorization and vectorization processing, the distribution axis of the data records included in the inquiry history dataset 151 is the same as the distribution axis of the data records included in the reference dataset 152.

### Displaying Screens According to First Embodiment

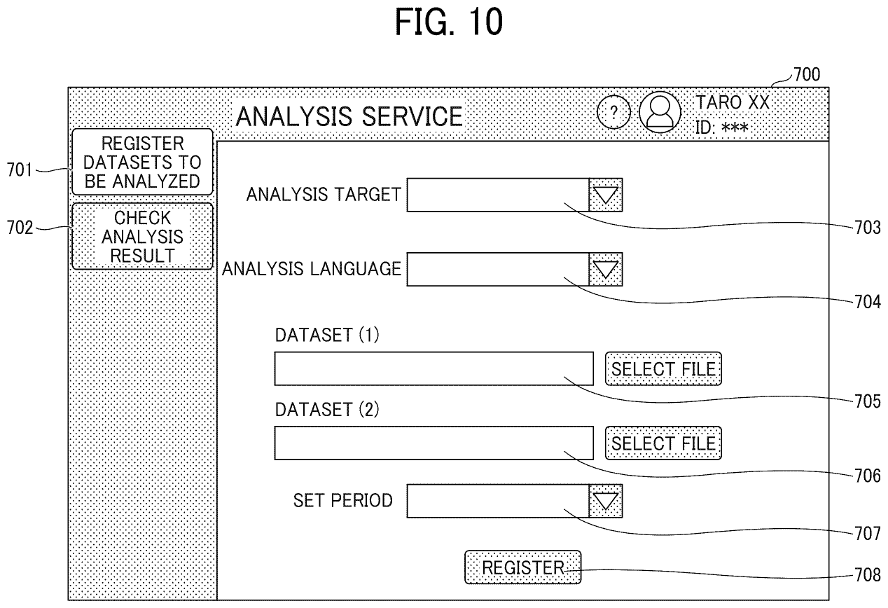

Various screens displayed by the display control unit 140 of the terminal apparatus 100 are described with reference to FIGS. 10 to 13.

### Dataset Registration Screen

FIG. 10 is a view of an example display of a dataset registration screen 700. Specifically, the dataset registration screen 700 is an example of the dataset registration screen displayed on the terminal apparatus 100 in step S103 of FIG. 8.

The dataset registration screen 700 includes a dataset registration screen display button 701, an analysis result screen display button 702, a model setting field 703, a language setting field 704, an inquiry history dataset setting field 705, a reference dataset setting field 706, an extraction setting field 707, and a registration button 708.

The dataset registration screen display button 701 is a button for displaying the dataset registration screen 700. In response to the administrator pressing the dataset registration screen display button 701, the transmission unit 120 of the terminal apparatus 100 requests the screen data for the dataset registration screen 700 from the information processing apparatus 200.

The analysis result screen display button 702 is a button for displaying the analysis result screen. The analysis result screen is described in detail later. In response to the administrator pressing the analysis result screen display button 702, the transmission unit 120 of the terminal apparatus 100 requests the screen data for the analysis result screen from the information processing apparatus 200.

The model setting field 703 is a field for setting information regarding a model to be used to vectorize the data records included in each dataset. The administrator selects a model to be used to vectorize the data records included in each dataset from a plurality of options (models) in the model setting field 703. In the example illustrated in FIG. 10, the model setting field 703 displays the options in a dropdown menu. The method of displaying the options (the method of selecting a model) in the model setting field 703 is not limited to the dropdown menu and may be any method such as radio buttons or text input. In a case where the model information is not set, the model setting field 703 may not be displayed.

The language setting field 704 is a field for setting a language of the datasets. The administrator inputs a language according to the datasets to be registered. In the example illustrated in FIG. 10, the language setting field 704 displays options (languages) in a dropdown menu. The method of displaying the options (the method of selecting a language) in the language setting field 704 is not limited to the dropdown menu and may be any method such as radio buttons or text input. In a case where the language is not set, the language setting field 704 may not be displayed.

The inquiry history dataset setting field 705 is a field for setting the inquiry history dataset 151. In the example illustrated in FIG. 10, in response to the administrator pressing a “select a file” button, the inquiry history dataset setting field 705 displays a list of files, allowing the administrator to select a file of the inquiry history dataset 151. The method of displaying or selecting a file in the inquiry history dataset setting field 705 is not limited to this method. For example, the inquiry history dataset setting field 705 may be a drag-and-drop field that allows the administrator to drag and drop the file of the inquiry history dataset 151 therein. Alternatively, the inquiry history dataset setting field 705 may be an input field that allows the administrator to input a location of the data server 300 where the inquiry history dataset 151 is stored.

The reference dataset setting field 706 is a field for setting the reference dataset 152. In the example illustrated in FIG. 10, in response to the administrator pressing a “select a file” button, the reference dataset setting field 706 displays a list of files, allowing the administrator to select a file of the reference dataset 152. The method of displaying or selecting a file in the reference dataset setting field 706 is not limited to this method. For example, the reference dataset setting field 706 may be a drag-and-drop field that allows the administrator to drag and drop the file of the reference dataset 152. Alternatively, the reference dataset setting field 706 may be an input field that allows the administrator to input a location of the data server 300 where the reference dataset 152 is stored.

The extraction setting field 707 is a field for setting information regarding a condition (extraction setting information) for extracting part of the data records from the inquiry history dataset 151. In the example illustrated in FIG. 10, the extraction setting field 707 is a field for setting period information as the extraction setting information. In the extraction setting field 707, the administrator sets a desired period for extracting data records to be analyzed among the data records included in the inquiry history dataset 151. In the example illustrated in FIG. 10, the extraction setting field 707 displays options (periods) in a dropdown menu. The method of displaying the options (periods) in the extraction setting field 707 is not limited to the dropdown menu. For example, the extraction setting field 707 may be an input field that allows the administrator to input a desired period or desired start and end dates. Further, the extraction setting information is not limited to the period information.

The registration button 708 is a button for registering the setting information and the datasets input by the administrator. In response to the administrator pressing the registration button 708, the transmission unit 120 of the terminal apparatus 100 transmits the setting information, the inquiry history dataset 151, and the reference dataset 152 input by the administrator to the information processing apparatus 200.

### Analysis Result Screen

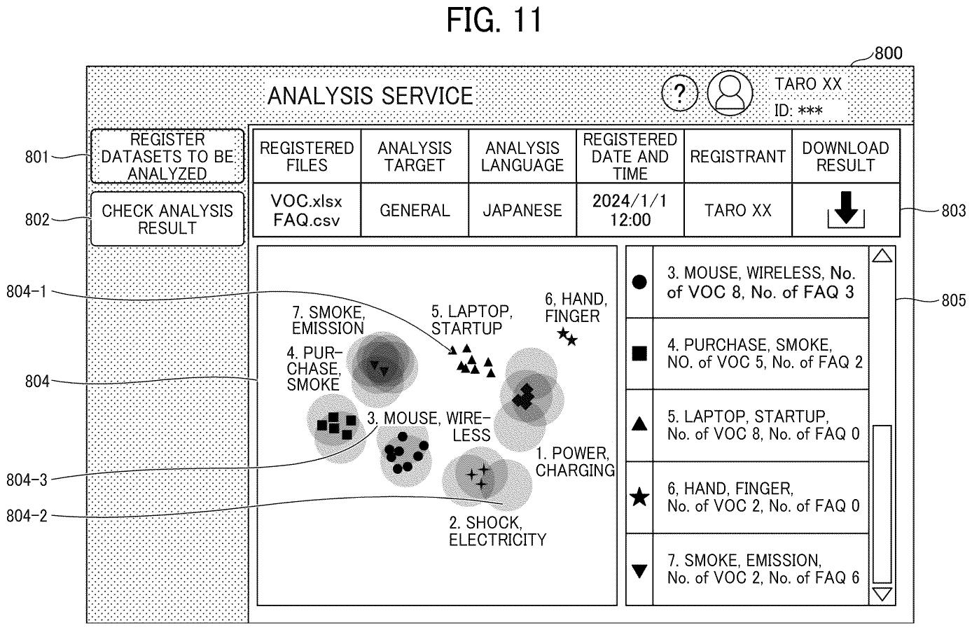

FIG. 11 is a view of an example display of an analysis result screen 800. Specifically, the analysis result screen 800 is an example of the analysis result screen displayed by the display control unit 140 of the terminal apparatus 100 in step S110 of FIG. 8. The analysis result screen 800 includes a dataset registration screen display button 801, an analysis result screen display button 802, a bibliography display field 803, the analysis result display field 804, and a classification category display field 805.

The dataset registration screen display button 801 is a button for displaying the dataset registration screen 700. The dataset registration screen display button 801 has the same function as the dataset registration screen display button 701 on the dataset registration screen 700.

The analysis result screen display button 802 is a button for displaying the analysis result screen 800. The analysis result screen display button 802 has the same function as the analysis result screen display button 702 on the dataset registration screen 700.

The bibliography display field 803 is a field for displaying bibliographic information relating to the analyzed datasets. In FIG. 11, the bibliography display field 803 includes a “registered files” field, an “analysis target” field, an “analysis language” field, a “registered date and time” field, a “registrant” field, and a “download analysis result” field.

The “registered files” field displays the file names and extensions of the datasets (analyzed datasets) registered on the dataset registration screen 700. The “analysis target” field displays the model information set on the dataset registration screen 700.

The “analysis language” field displays the language information registered on the dataset registration screen 700. The “registered date and time” field displays the date and time when the datasets and the setting information were registered.

The “registrant” field displays information regarding the administrator who has registered the datasets and the setting information. The “download analysis result” field displays a button for downloading the analysis result.

The bibliography display field 803 illustrated in FIG. 11 is merely an example. In another embodiment, the bibliography display field 803 may display part of the bibliographic information illustrated in FIG. 11 or display other information set on the dataset registration screen 700.

The analysis result display field 804 is a field for displaying the result of the analysis of the data records included in each dataset. The details of the analysis result display field 804 are as described with reference to FIG. 7. The method of displaying the analysis result display field 804 is not limited to the method described with reference to FIG. 7. The analysis result display field 804 may display the distribution of the data records included in the inquiry history dataset 151 and the distribution of the data records included in the reference dataset 152 side by side, instead of displaying the distributions in an overlapping manner as in FIG. 7. The analysis result display field 804 displays the distribution of the data records included in the inquiry history dataset 151 and the distribution of the data records included in the reference dataset 152 together.

The classification category display field 805 is a field for displaying the detail of each classification category into which the classification unit 230 has classified the data records included in each dataset. In FIG. 11, the classification category display field 805 displays the classification category number, the term representing the classification category, the number of data records classified into the classification category among the data records included in the inquiry history dataset 151, and the number of data records classified into the classification category among the data records included in the reference dataset 152. In FIG. 11, for example, the classification category display field 805 displays that eight data records among the data records included in the inquiry history dataset 151 and three data records among the data records included in the reference dataset 152 are classified into the classification category whose classification category number is “3” and term representing the classification category is “mouse, wireless.”

### Interaction

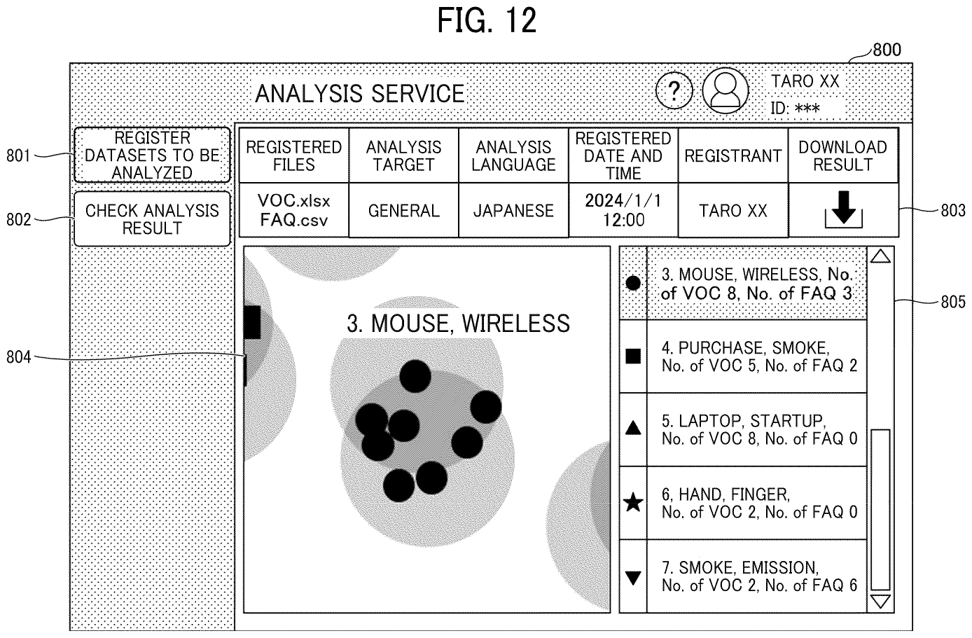

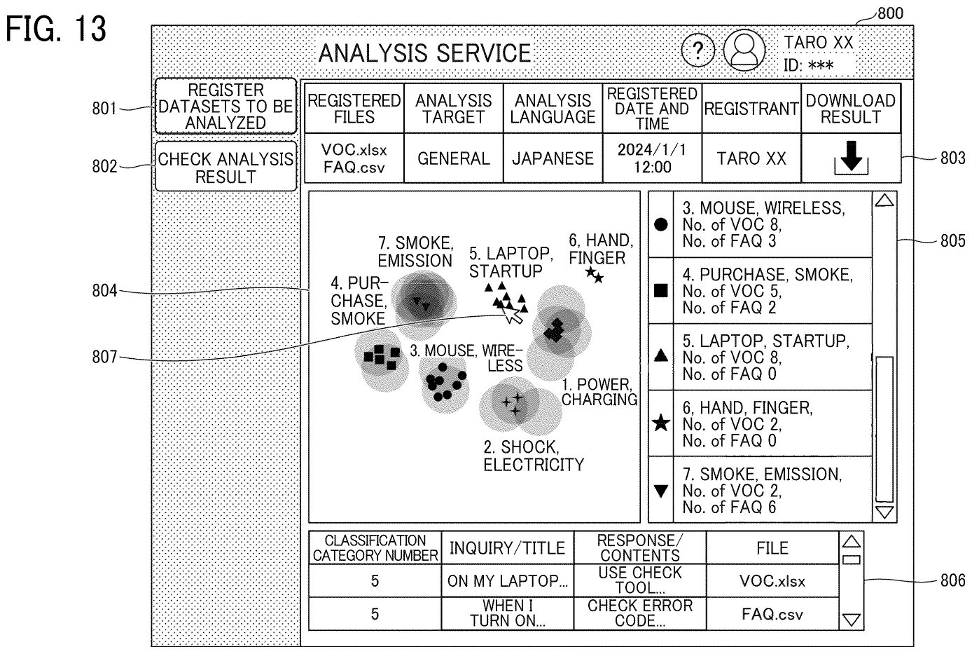

Example user interaction on the analysis result screen 800 and another example display of the analysis result screen 800 are described with reference to FIGS. 12 and 13. Components having the same or substantially the same configuration as components illustrated in FIG. 11 are denoted by the same reference signs, and the descriptions thereof are omitted.

FIG. 12 is a view of example user interaction on the analysis result screen 800. In the analysis result display field 804, the administrator may perform an operation such as scrolling, dragging, zooming in (pinch-in), or zooming out (pinch-out). The acceptance unit 130 of the terminal apparatus 100 receives an operation from the administrator. The analysis result display field 804 changes the display according to the operation from the administrator.

For example, in a case where the administrator performs a pinch-in operation on the area in which the data records classified into the classification category whose classification category number is “3” and term representing the classification category is “mouse, wireless” are displayed, the analysis result display field 804 displays a magnified view of the area as illustrated in FIG. 12.

FIG. 13 is a view of another example user interaction on the analysis result screen 800. In other words, FIG. 13 illustrates another display example of the analysis result screen 800.

The analysis result screen 800 illustrated in FIG. 13 includes a data display field 806 in addition to the configuration described with reference to FIG. 11. Further, the analysis result screen 800 displays a pointer 807, which indicates a location where the administrator is operating.

The data display field 806 is a field for displaying the details of data records classified into the classification category selected by the administrator. The data display field 806 displays the contents of the analysis result data. In FIG. 13, “classification category number,” “inquiry/title,” “response/contents,” and “dataset name (file)” included in the analysis result data are displayed.

The administrator may select a classification category either in the analysis result display field 804 or the classification category display field 805.

In FIG. 13, the pointer 807 on the analysis result display field 804 selects a classification category whose classification category number is “5” and term representing the classification category is “laptop, startup,” and the data display field 806 displays data records classified into the classification category with the classification category number 5.

Specifically, the data display field 806 displays a data record of the inquiry history dataset 151, which is classified into the classification category with the classification category number 5 and indicates an inquiry “on my laptop . . . ” and a response “use check tool . . . ” Further, the data display field 806 displays a data record of the reference dataset 152, which is classified into the classification category with the classification category number 5 and indicates a title “when I turn on . . . ” and contents “check error code . . . . ”

According to the present embodiment, the terminal apparatus 100 transmits the setting information (model setting information, language setting information, and extraction setting information), the inquiry history dataset 151, and the reference dataset 152, which have been set by the terminal apparatus 100, to the information processing apparatus 200. The information processing apparatus 200 analyzes the data records included in the inquiry history dataset 151 and the reference dataset 152 based on the setting information. The information processing apparatus 200 extracts data records from the received datasets 151 and 152 based on the extraction setting information, vectorizes the data records based on the model setting information and the language information, and classifies the data records. Further, the information processing apparatus 200 distributes the data records.

The information processing apparatus 200 generates the analysis result screen 800, which displays the distribution of the data records included in the inquiry history dataset 151 and the distribution of the data records included in the reference dataset 152 together. The terminal apparatus 100 displays the analysis result screen 800, which displays the distribution of the data records included in the inquiry history dataset 151 and the distribution of the data records included in the reference dataset 152 together.

Since the analysis result screen 800 displays the distribution of the data records included in the inquiry history dataset 151 and the distribution of the data records included in the reference dataset 152 together, the administrator recognizes the difference between the distribution of the data records included in the inquiry history dataset 151 and the distribution of the data records included in the reference dataset 152.

In this way, since the administrator recognizes the difference between the distribution of the data records included in the inquiry history dataset 151 and the distribution of the data records included in the reference dataset 152, the administrator figures out what data records are desirable to add to or remove from the reference dataset 152.

### Functional Configuration of Information Processing System According to Second Embodiment

An information processing system 1000A according to a second embodiment of the present disclosure is described below. The information processing system 1000A according to the second embodiment has the same configuration as the information processing system 1000 according to the first embodiment, except that the information processing system 1000A includes an information processing apparatus 200A, which determines a classification category to be presented to the administrator and outputs data for displaying the determined classification category to the terminal apparatus 100. The following description focuses on the difference between the first embodiment and the second embodiment. In the second embodiment, components having the same or substantially the same functional configuration as the components according to the first embodiment are denoted by the same reference signs, and the descriptions thereof are omitted.

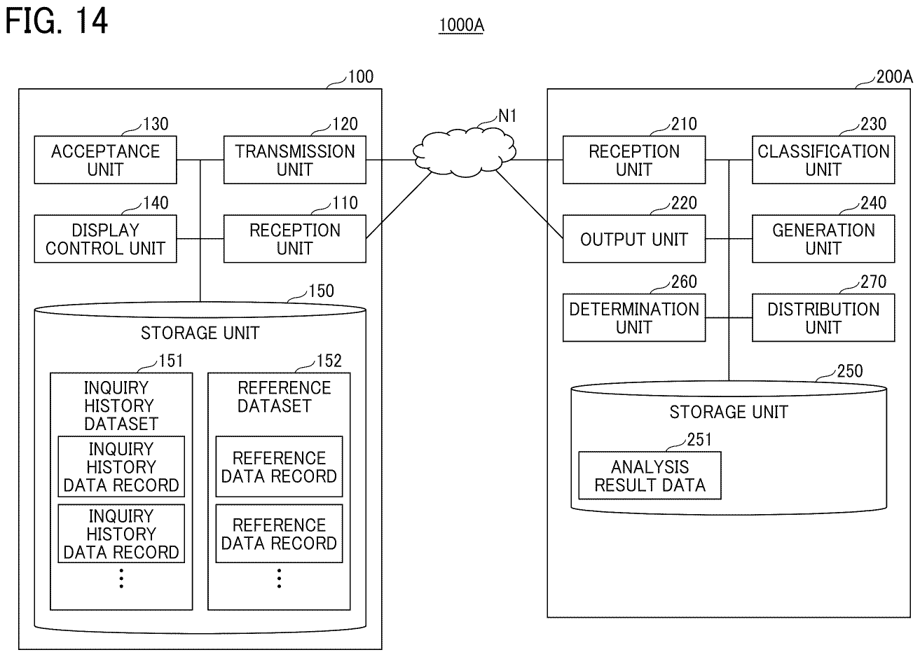

A functional configuration of the information processing system 1000A according to the second embodiment is described with reference to FIG. 14. FIG. 14 is a diagram illustrating an example functional configuration of the information processing system 1000A according to the second embodiment.

The information processing system 1000A according to the second embodiment includes the terminal apparatus 100, the information processing apparatus 200A, and the data server 300. The information processing system 1000A according to the second embodiment has the same configuration as the information processing system 1000 according to the first embodiment, except that the information processing system 1000A includes the information processing apparatus 200A, instead of the information processing apparatus 200.

The information processing apparatus 200A includes a determination unit 260 in addition to the functional configuration of the information processing apparatus 200 according to the first embodiment.

The determination unit 260 determines a classification category to be presented to the administrator. The classification category to be presented to the administrator refers to a classification category to be presented to the administrator in a different manner from the other classification categories. Presenting a classification category in a different manner includes, for example, highlighting the classification category in a noticeable way, displaying the classification category in an identifiable way, or displaying detailed information regarding the classification category. The classification category to be presented to the administrator may be a classification category for which the administrator is recommended to take some action, such as adding or reducing data records to or from the reference dataset 152.

For each of the classification categories into which the classification unit 230 has classified data records included in each dataset, the determination unit 260 determines whether to present the classification category to the administrator based on the number of data records classified into the classification category as a result of the analysis of the data records included in the inquiry history dataset 151 and the number of data records classified into the classification category as a result of the classification of the data records included in the reference dataset 152. The determination unit 260 may determine whether to present the classification category to the administrator according to a presentation condition.

The presentation condition refers to a condition or a priority for determining a classification category to be presented to the administrator. For example, the presentation condition may be a threshold value for the difference between the number of data records classified into a classification category as a result of the analysis of the data records included in the inquiry history dataset 151 and the number of data records classified into the classification category as a result of the classification of the data records included in the reference dataset 152. In this case, the determination unit 260 determines the classification category to be presented to the administrator according to the threshold value.

In one example presentation condition, the classification category determined to be presented to the administrator may be a classification category having the largest difference between the number of data records classified into the classification category as a result of the analysis of the data records included in the inquiry history dataset 151 and the number of data records classified into the classification category as a result of the classification of the data records included in the reference dataset 152. Alternatively, the presentation condition may be a priority setting. In this case, the classification categories may be presented to the administrator in descending order of the difference between the number of data records classified into the classification category as a result of the analysis of the data records included in the inquiry history dataset 151 and the number of data records classified into the classification category as a result of the classification of the data records included in the reference dataset 152.

In another example presentation condition, the classification category determined to be presented to the administrator may be a classification category whose number of data records classified into the classification category as a result of the classification of the data records included in the reference dataset 152 is zero and whose difference between the number of data records classified into the classification category as a result of the analysis of the data records included in the inquiry history dataset 151 and the number of data records classified into the classification category as a result of the classification of the data records included in the reference dataset 152 is equal to or greater than a threshold value.

### Processing Procedure According to Second Embodiment

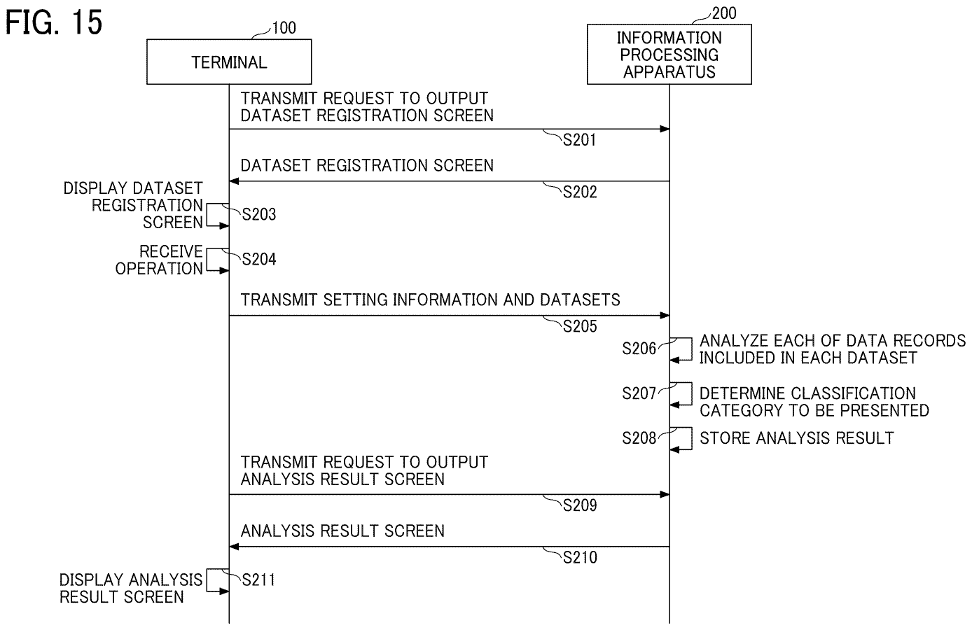

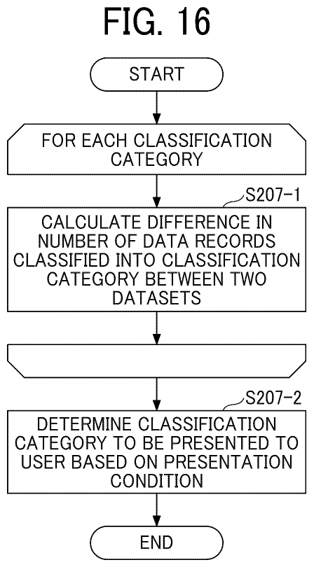

A process performed by the information processing system 1000A according to the second embodiment is described with reference to FIGS. 15 and 16. FIG. 15 is a sequence diagram illustrating an example process performed by the information processing system 1000A according to the present embodiment.

The processing in steps S201 to S206 is the same as the processing in steps S101 to S106 of FIG. 8.

In step S207, the determination unit 260 of the information processing apparatus 200A determines a classification category to be presented to the administrator. Specifically, for each of the classification categories into which the classification unit 230 has classified the data records included in each dataset, the determination unit 260 determines whether to present the classification category to the administrator based on the number of data records classified into the classification category as a result of the analysis of the data records included in the inquiry history dataset 151 and the number of data records classified into the classification category as a result of the classification of the data records included in the reference dataset 152. The processing in step S207 is described in detail later with reference to FIG. 16.

The processing in steps S208 and S209 is the same as the processing in steps S107 and S108 of FIG. 8.

In step S210, in response to the analysis result screen output request received in step S209, the generation unit 240 generates distribution data of the data records (inquiry history data records) included in the inquiry history dataset 151 and distribution data of the data records (reference data records) included in the reference dataset 152 based on the analysis result obtained in step S206. Further, the generation unit 240 generates data for displaying the classification category to be presented to the administrator, as determined in step S207. In other words, the generation unit 240 generates data for displaying the analysis result screen on the terminal apparatus 100. The data for displaying the analysis result screen includes the distribution data of the data records (inquiry history data records) included in the inquiry history dataset 151, the distribution data of the data records (reference data records) included in the reference dataset 152, and the data for displaying the classification category determined in step S207.

The process of determining the classification category to be presented to the administrator (step S207) is described in detail with reference to FIG. 16. FIG. 16 is a flowchart illustrating an example of the process of determining the classification category to be presented to the administrator according to the present embodiment.

In step S207-1, for each of the classification categories into which the classification unit 230 has classified the data records included in each dataset, the determination unit 260 calculates the difference between the number of data records classified into the classification category as a result of the analysis of the data records included in the inquiry history dataset 151 and the number of data records classified into the classification category as a result of the classification of the reference dataset 152.

In step S207-2, the determination unit 260 determines the classification category to be presented to the administrator based on each difference calculated in step S207-1 and the presentation condition.

For example, in the presentation condition in which a classification category having the largest difference among the differences calculated for each classification category in step S207-1 is determined as the classification category to be presented to the administrator, the determination unit 260 determines the classification category having the largest difference as the classification category to be presented to the administrator.

### Displaying Analysis Result Screen According to Second Embodiment

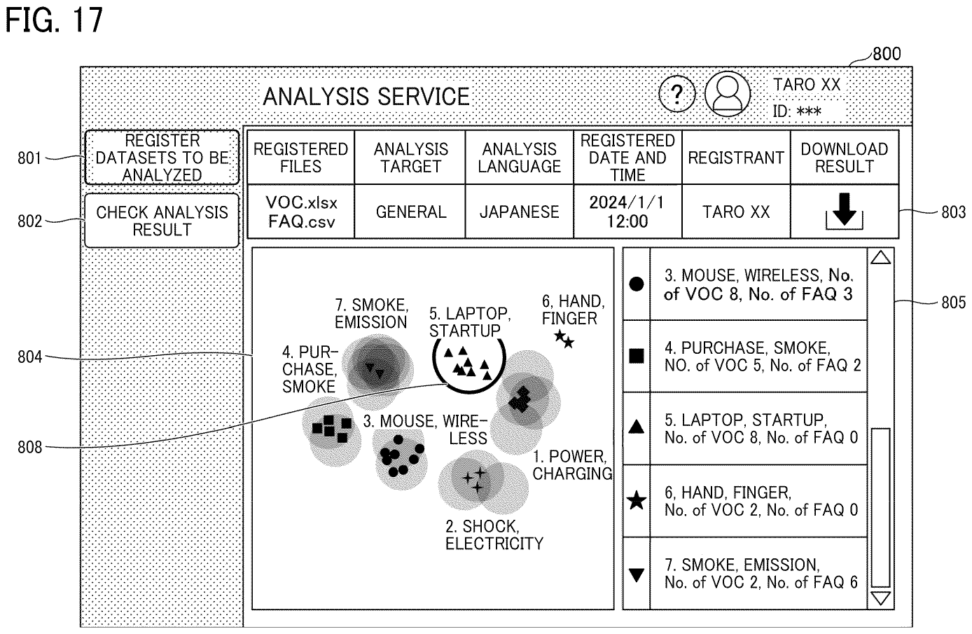

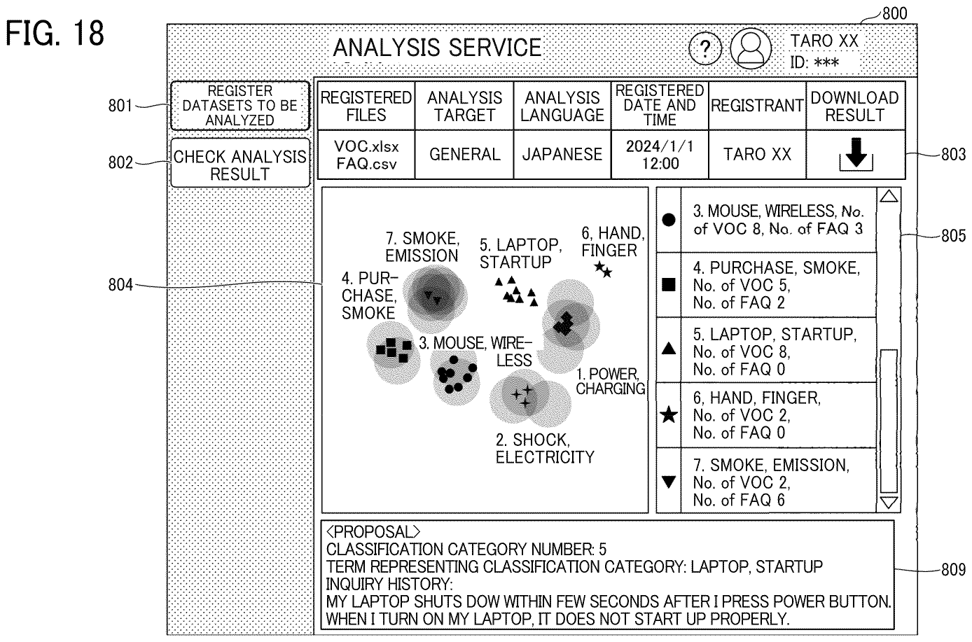

The display of the analysis result screen according to the second embodiment is described with reference to FIGS. 17 and 18. The display of the analysis result screen according to the second embodiment is different from the display of the analysis result screen according to the first embodiment in that the analysis result screen according to the second embodiment includes a classification category determined to be presented to the administrator by the determination unit 260. Components having the same or substantially the same configuration as the components according to the first embodiment are denoted by the same reference signs, and the descriptions thereof are omitted.

FIG. 17 is a view of an example display of the analysis result screen 800. Specifically, the analysis result screen 800 illustrated in FIG. 17 is an example of the analysis result screen displayed on the terminal apparatus 100 in step S210 of FIG. 15. The analysis result screen 800 displays a FIG. 808 on the analysis result display field 804 to highlight the classification category determined to be presented to the administrator by the determination unit 260.

In FIG. 17, as an example, the FIG. 808, which highlights the classification category determined to be presented to the administrator, is an unfilled circle. The FIG. 808 may have any other shape.

In FIG. 17, the FIG. 808 highlights the classification category whose classification category number is “5” and term representing the classification category is “laptop, startup” as the classification category determined to be presented to the administrator.

FIG. 18 is a view of another example display of the analysis result screen 800. Specifically, the analysis result screen 800 illustrated in FIG. 18 is an example of the analysis result screen displayed on the terminal apparatus 100 in step S210 of FIG. 15.

In FIG. 18, the analysis result screen 800 displays a classification category presentation field 809 to present the classification category determined to be presented to the administrator by the determination unit 260. The classification category presentation field 809 is a field that presents the classification category determined to be presented to the administrator by the determination unit 260.

In FIG. 18, the classification category presentation field 809 displays the classification category number indicating the classification category determined to be presented to the administrator, the term representing the classification category, and the details of the data records classified into the classification category among the data records included in the inquiry history dataset 151. The contents displayed in the classification category presentation field 809 are not limited thereto. The classification category presentation field 809 may also display the number of data records classified into the classification category as a result of the analysis of the data records included in the inquiry history dataset 151 and the number of data records classified into the classification category as a result of the classification of the data records included in the reference dataset 152.

In FIG. 18, the classification category presentation field 809 presents the administrator with the classification category whose classification category number is “5” and term representing the classification category is “laptop, startup.” One of the data records classified into the classification category with the classification category number 5 among the inquiry history dataset 151 includes an inquiry “my laptop shuts down within a few seconds after I press the power button.”

With this configuration, the administrator who manages the reference dataset 152 recognizes what inquiries are included in the presented classification category and easily figures out what data records are desirable to add to the reference dataset 152.

According to the present embodiment, the determination unit 260 determines a classification category to be presented to the administrator among the classification categories into which the classification unit 230 has classified the data records included in the datasets 151 and 152, based on the number of data records classified into each of the classification categories as a result of the analysis of the data records included in the inquiry history dataset 151, the number of data records classified into each of the classification categories as a result of the classification of the data records included in the reference dataset 152, and the presentation condition.

Moreover, according to the present embodiment, the classification category determined to be presented to the administrator by the determination unit 260 is presented on the analysis result screen 800 displayed on the terminal apparatus 100.

Since the analysis result screen 800 presents the classification category determined to be presented to the administrator, the administrator who manages the reference dataset 152 recognizes the classification category for which adding or removing data records is recommended. Accordingly, the administrator figures out what data records are desirable to add to or remove from the reference dataset 152.

The analysis result screen 800 displays the classification category determined to be presented to the administrator and the details of the data records classified into the presented classification category among the data records included in the inquiry history dataset 151. Accordingly, the administrator grasps the contents of the data records of the inquiry history dataset 151 classified into the presented classification category. This configuration allows the administrator to easily figure out what data records are desirable to add to or remove from the reference dataset 152.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

For example, a process performed by a plurality of apparatuses may be performed by a single apparatus, and a process performed by a single apparatus may be performed by a plurality of apparatuses.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. An information processing apparatus communicably connected with a terminal apparatus, the information processing apparatus comprising:
a memory that stores a plurality of reference data records prepared in advance to serve as a reference for a user to respond to an inquiry and a plurality of inquiry history data records each indicating a history of an inquiry received in a past; and
circuitry configured to:
generate distribution information of the plurality of reference data records in which the plurality of reference data records is distributed along a predetermined axis and distribution information of the plurality of inquiry history data records in which the plurality of inquiry history data records is distributed along the predetermined axis; and
output data including the generated distribution information of the plurality of reference data records and the generated distribution information of the plurality of inquiry history data records to the terminal apparatus for display at the terminal apparatus.

2. The information processing apparatus according to claim 1,
wherein the circuitry is configured to receive the plurality of reference data records and the plurality of inquiry history data records from the terminal apparatus or another terminal other than the terminal apparatus, and
the memory stores the plurality of reference data records and the plurality of inquiry history data records that have been received.

3. The information processing apparatus according to claim 1, wherein the circuitry is configured to:
classify each of the plurality of reference data records and each of the plurality of inquiry history data records into a corresponding one of predetermined classification categories; and
generate the distribution information of the plurality of reference data records in which the plurality of reference data records each classified into the corresponding one of the predetermined classification categories is distributed along the predetermined axis and the distribution information of the plurality of inquiry history data records in which the plurality of inquiry history data records each classified into the corresponding one of the predetermined classification categories is distributed along the predetermined axis.

4. The information processing apparatus according to claim 3, wherein the circuitry is configured to:
perform a same vectorization process on each of the plurality of reference data records and each of the plurality of inquiry history data records; and
classify each of the plurality of reference data records and each of the plurality of inquiry history data records on which the same vectorization process has been performed into the corresponding one of the predetermined classification categories.

5. The information processing apparatus according to claim 3, wherein the circuitry is configured to:
analyze each of the plurality of reference data records and each of the plurality of inquiry history data records to determine the predetermined classification categories; and
classify each of the plurality of reference data records and each of the plurality of inquiry history data records into the corresponding one of the predetermined classification categories that have been determined.

6. The information processing apparatus according to claim 1, wherein, in response to receiving an output request transmitted from the terminal apparatus, the circuitry is configured to output the generated distribution information of the plurality of reference data records and the generated distribution information of the plurality of inquiry history data records to the terminal apparatus.

7. The information processing apparatus according to claim 1, wherein the circuitry is configured to generate the distribution information of the plurality of inquiry history data records and the distribution information of the plurality of reference data records such that distribution of the plurality of inquiry history data records each represented by a first figure and distribution of the plurality of reference data records each represented by a second figure are to be displayed in an overlapping manner, the first figure being to be displayed at a position of a corresponding one of the plurality of inquiry history data records in the distribution of the plurality of inquiry history data records, the second figure being to be displayed at a position of a corresponding one of the plurality of reference data records in the distribution of the plurality of reference data records.

8. The information processing apparatus according to claim 7, wherein the first figure and the second figure have different shapes.

9. The information processing apparatus according to claim 3, wherein the circuitry is configured to:
determine a particular predetermined classification category to be presented to the user among the predetermined classification categories based on a number of reference data records classified into each of the predetermined classification categories among the plurality of reference data records and a number of inquiry history data records classified into each of the predetermined classification categories among the plurality of inquiry history data records; and
output data for displaying the particular predetermined classification category to the terminal apparatus.

10. The information processing apparatus according to claim 1, wherein the plurality of reference data records includes at least one of a product manual or a history of a response to the inquiry received in the past.

11. The information processing apparatus according to claim 1, wherein the circuitry is configured to generate the distribution information of the plurality of reference data records and the distribution information of the plurality of inquiry history data records such that distribution of the plurality of reference data records and distribution of the plurality of inquiry history data records are to be displayed side by side.

12. An information processing system comprising:
the information processing apparatus according to claim 1; and
the terminal apparatus including terminal circuitry, the terminal circuitry being configured to display, on a display, the distribution information of the plurality of reference data records and the distribution information of the plurality of inquiry history data records.

13. An information processing method performed by a computer communicably connected with a terminal apparatus, the information processing method comprising:
storing a plurality of reference data records prepared in advance to serve as a reference for a user to respond to an inquiry and a plurality of inquiry history data records each indicating a history of an inquiry received in a past;
generating distribution information of the plurality of reference data records in which the plurality of reference data records is distributed along a predetermined axis and distribution information of the plurality of inquiry history data records in which the plurality of inquiry history data records is distributed along the predetermined axis; and
outputting data including the generated distribution information of the plurality of reference data records and the generated distribution information of the plurality of inquiry history data records to the terminal apparatus for display at the terminal apparatus.

14. A non-transitory recording medium storing a plurality of instructions which, when executed by one or more processors, causes the one or more processors to perform an information processing method comprising:
storing a plurality of reference data records prepared in advance to serve as a reference for a user to respond to an inquiry and a plurality of inquiry history data records each indicating a history of an inquiry received in a past;
generating distribution information of the plurality of reference data records in which the plurality of reference data records is distributed along a predetermined axis and distribution information of the plurality of inquiry history data records in which the plurality of inquiry history data records is distributed along the predetermined axis; and
outputting data including the generated distribution information of the plurality of reference data records and the generated distribution information of the plurality of inquiry history data records to the terminal apparatus for display at the terminal apparatus.
